(19) United States
(12) Patent Application Publication
(10) Pub. No.: US 2004/0263983 A1
(43) Pub. Date: Dec. 30, 2004

(54) Anti-reflective coatings and structures

(75) Inventor: Michael A. Acree, Sherman Oaks, CA (US)

Correspondence Address: KOESTNER BERTANI LLP, 18662 MACARTHUR BLVD, SUITE 400, IRVINE, CA, 92612, US

(73) Assignee: Lockheed Martin Corporation, Bethesda, MD (US)

(21) Appl. No.: 10/838,808

(22) Filed: May 3, 2004

Related U.S. Application Data
(60) Provisional application No. 60/467,608, filed on May 2, 2003.

(51) Int. Cl. G02B 1/10

(52) U.S. Cl. 359/586; 359/589

(57) ABSTRACT

An antireflective coating that is effective over an extended spectral region for a wide range of angles of incidence includes a number of homogeneous layers of equal optical thicknesses having small and constant differences (δn) between the refractive indices of two adjacent sublayers. The adjacent layers with small differences in refractive indices n have been removed from the coating when the AR performance, angular variation, and the bandwidth of the coating did not degrade beyond an acceptable threshold.

### BACKGROUND

Antireflection (AR) coatings are used on optical surfaces primarily to prevent loss of light and to reduce stray light produced by multiple reflections between different surfaces of an optical system in the operating spectral region of the optical system. When an omnidirectional AR coating is deposited onto an interface between two media, such as air and a surface of the optical system, the AR coating suppresses the reflection of s- and p-polarized light incident on the interface at all angles of incidence except 90 degrees for a narrow spectral region of light wavelengths. A “perfect” (AR) coating would completely remove the reflection from an interface between two media for all wavelengths, polarizations, and angles of incidence.

The utility of AR numerical coating designs depends on the width of the spectral region over which the coatings are effective. Existing normal-incidence AR coating designs typically operate over spectral ranges defined by lower wavelengths XL and upper wavelengths λ_{L} for which 0.85<λ_{U}/λ_{L}<5.0. What is desired is the ability to achieve a high reflectance over an extended spectral region for a wide range of angles of incidence.

### SUMMARY

An antireflective coating is disclosed that is effective over an extended spectral region for a wide range of angles of incidence.

In some embodiments, an apparatus with an antireflective (AR) coating, includes a plurality of coating layers. The refractive indices of the layers vary between the refractive index of the substrate on which the coating is deposited, and the refractive index of the medium in which the apparatus is utilized. The differences in the refractive indices between adjacent layers is less than the difference between the refractive index of the substrate and the refractive index of the medium.

The foregoing has outlined rather broadly the features and technical advantages of embodiments of the present invention so that those skilled in the art may better understand the detailed description of embodiments of the invention that follows.

### BRIEF DESCRIPTION OF THE FIGURES

A more complete understanding of embodiments of the present invention and advantages thereof may be acquired by referring to the following description taken in conjunction with the accompanying drawings in which like reference numbers indicate like features and wherein:

FIGS. 1A through 1F show the structure and effective refractive-index profiles of various types of embodiments of AR coatings;

FIG. 2 is a graph of reflectance as a function of angle of incidence for s- and p-polarized light of an interface between a substrate of index 3.00 and air;

FIG. 3A is a graph showing a refractive index profile for a range of optical thicknesses of a conventional 3-layer AR coating for a 3.00/air interface;

FIG. 3B is a graph showing angular variation of the average reflectance for unpolarized light for a range of incidence angles of a conventional 3-layer AR coating for a 3.00/air interface; FIG. 3C is a graph showing spectral variation of the average reflectance for 30, 40, 50, 60, 70, 80, and 85 degrees of incidence angle for a range of wavelengths of a conventional 3-layer AR coating for a 3.00/air interface;

FIG. 3D is a graph showing a refractive index profile for a range of optical thicknesses of a 200-layer AR coating for a 3.00/air interface;

FIG. 3E is a graph showing angular variation of the average reflectance for unpolarized light for a range of incidence angles of a 200-layer AR coating for a 3.00/air interface;

FIG. 3F is a graph showing spectral variation of the average reflectance for 30, 40, 50, 60, 70, 80, and 85 degrees of incidence angle for a range of wavelengths of a 200-layer AR coating for a 3.00/air interface;

FIG. 3G is a graph showing a refractive index profile for a range of optical thicknesses of a 47-layer AR coating for a 1.48/air interface;

FIG. 3H is a graph showing angular variation of the average reflectance for unpolarized light for a range of incidence angles of a 47-layer AR coating for a 1.48/air interface;

FIG. 3I is a graph showing spectral variation of the average reflectance for 30, 40, 50, 60, 70, 80, and 85 degrees of incidence angle for a range of wavelengths of a 47-layer AR coating for a 1.48/air interface;

FIG. 3J is a graph showing a refractive index profile for a range of optical thicknesses of a single layer AR coating for a 3.00-1.48 interface; FIG. 3K is a graph showing angular variation of the average reflectance for unpolarized light for a range of incidence angles of a single layer AR coating for a 3.00-1.48 interface;

FIG. 3L is a graph showing spectral variation of the average reflectance for 30, 40, 50, 60, 70, 80, and 85 degrees of incidence angle for a range of wavelengths of a single layer AR coating for a 3.00-1.48 interface;

FIG. 3M is a graph showing a refractive index profile for a range of optical thicknesses of a 6-layer AR coating for a 3.00/1.48 interface;

FIG. 3N is a graph showing angular variation of the average reflectance for unpolarized light for a range of incidence angles of a6-layer AR coating for a 3.00/1.48 interface;

FIG. 3O is a graph showing spectral variation of the average reflectance for 30, 40, 50, 60, 70, 80, and 85 degrees of incidence angle for a range of wavelengths of a 6-layer AR coating for a 3.00/1.48 interface;

FIG. 3P is a graph showing a refractive index profile for a range of optical thicknesses of a 53-layer AR coating for a 3.00/air interface;

FIG. 3Q is a graph showing angular variation of the average reflectance for unpolarized light for a range of incidence angles of a 53-layer AR coating for a 3.00/air interface;

FIG. 3R is a graph showing spectral variation of the average reflectance for 30, 40, 50, 60, 70, 80, and 85 degrees of incidence angle for a range of wavelengths of a 53-layer AR coating for a 3.00/air interface;

FIG. 3S is a graph showing a refractive index profile for a range of optical thicknesses of a 7-layer AR coating for a 3.00/air interface;

FIG. 3T is a graph showing angular variation of the average reflectance for unpolarized light for a range of incidence angles of a 7-layer AR coating for a 3.00/air interface;

FIG. 3U is a graph showing spectral variation of the average reflectance for 30, 40, 50, 60, 70, 80, and 85 degrees of incidence angle for a range of wavelengths of a 7-layer AR coating for a 3.00/air interface;

FIG. 3V is a graph showing a refractive index profile for a range of optical thicknesses of a 4-layer AR coating for a 3.00/air interface;

FIG. 3W is a graph showing angular variation of the average reflectance for unpolarized light for a range of incidence angles of a 4-layer AR coating for a 3.00/air interface;

FIG. 3X is a graph showing spectral variation of the average reflectance for 30, 40, 50, 60, 70, 80, and 85 degrees of incidence angle for a range of wavelengths of a 4-layer AR coating for a 3.00/air interface;

FIG. 4 is a graph of the cosecant of the angle of refraction in layers of different refractive indices as a function of angle of incidence;

FIG. 5A is a graph showing a refractive index profile for a range of optical thicknesses of an AR coating comprised of reststrahlen material for a 3.00/air interface;

FIG. 5B is a graph showing angular variation of the average reflectance for unpolarized light for a range of incidence angles of an AR coating comprised of reststrahlen material for a 3.00/air interface;

FIG. 5C is a graph showing spectral variation of the average reflectance for 30, 40, 50, 60, 70, 80, and 85 degrees of incidence angle for a range of wavelengths of an AR coating comprised of reststrahlen material for a 3.00/air interface;

FIG. 6 shows experimental performance of a wide-angle AR coating for the Si/air interface using the reststrahlen effect in a SiO₂ layer;

FIG. 7 shows a flow diagram summarizing an embodiment of a method for designing AR coatings; and

FIG. 8 shows a block diagram of a system that can be used to implement embodiments of processes for designing AR coatings.

### DETAILED DESCRIPTION OF THE FIGURES

Various embodiments of techniques for designing AR coatings that achieve high reflectance over an extended spectral region for a wide range of angles of incidence include using layers of material with refractive indices that are close to the refractive index of the incident medium. Embodiments of AR coatings designed using techniques disclosed herein exhibit reflectances for unpolarized light in the wavelength range of 5.0-8.0 μm (micrometers) that remain below 0.02 and 0.05 for angles of incidence up to 85 degrees and 89 degrees, respectively. The AR coatings include relatively few layers compared to previously known AR coatings, and can be more easily manufactured compared to AR coatings requiring more layers. In some embodiments, more desirable reflectance characteristics can be achieved over a range of incidence angles by utilizing smaller index increments and more layers.

1.0 Performance Characteristics of Homogenous and Inhomogeneous AR Coatings

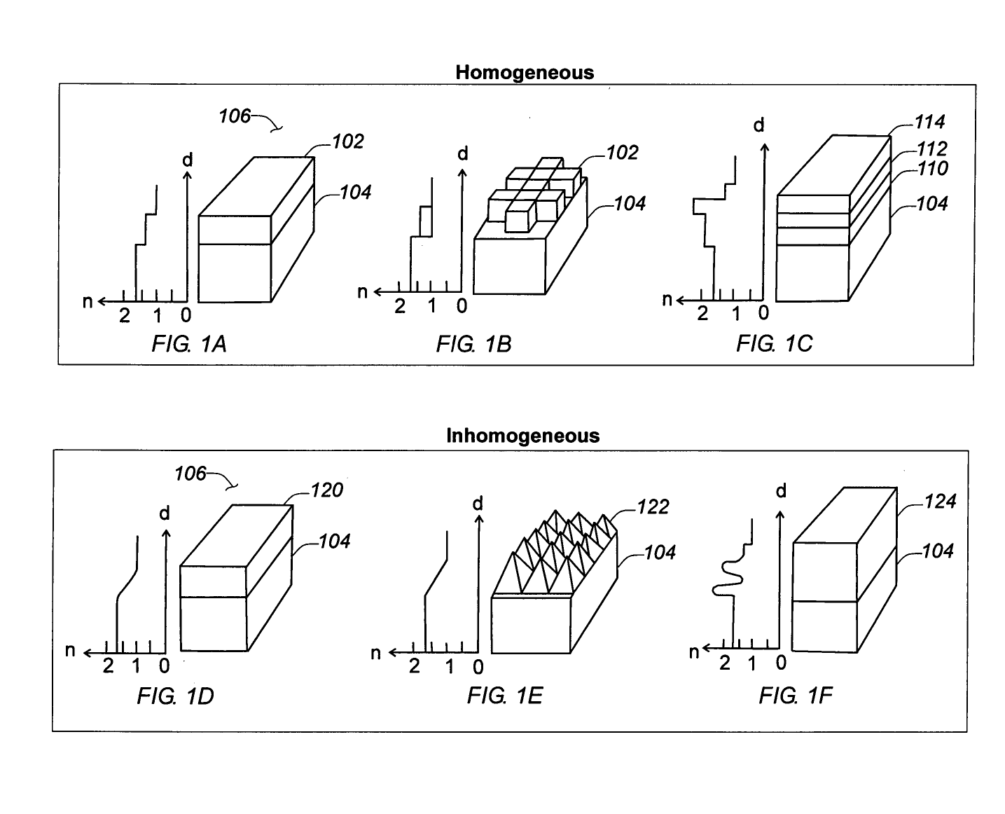

AR coatings can be classified into two basic types: those based on homogeneous layers as shown in FIGS. 1A through 1C, and those that consist of an inhomogeneous layer as shown in FIGS. 1D through 1F.

1.1 Homogeneous AR Coatings

FIG. 1A shows a single homogeneous coating layer 102 of refractive index n that reduces reflectance R to zero at a normal (90 degree) incidence angle between substrate 104 of refractive index nₛ and medium 106 of refractive index nₘ for light of wavelength λ. The optical thickness d of coating layer 102 is equal to λ/4 and the refractive indices of substrate 104 and medium 106 satisfy the relation n=(nₛnₘ)^{0.5}

When nₘ=1.0, the relation n=(nₛnₘ)^{0.5} can only be satisfied with dense films or coating layers 102 of materials provided that nₛ>2.0. Most optical glass materials have refractive indices that are lower than 2.0. A lower effective index n of the material is achieved when coating layer 102 is porous or patterned as shown in FIG. 1B. When coating layer 102 is patterned, for example, as a series of adjacent cubes as shown, the dimensions of the patterns are less than the wavelength of light.

It is possible to obtain zero reflectance at one or more wavelengths through use of multiple thin layers 110, 112, 114 as shown in FIG. 1C even if the relation n=(nₛnₘ)^{0.5} is not satisfied.

1.2 Inhomogeneous AR Coatings

It is also possible to reduce the reflectance of the interface between substrate 104 and medium 106 by depositing an inhomogeneous layer 120 with a refractive index that varies gradually from nₛ to nₘ onto substrate 104 as shown in FIG. 1D. For satisfactory performance, the optical thickness d of the inhomogeneous layer 120 typically exceeds at least one or two upper wavelengths λ_{U}, but the overall thickness of layer 120 is not critical.

Inhomogeneous layers are typically more difficult to deposit with precise control, however. The spectral properties of an inhomogeneous layer can be approximated by use of a number of thin layers of equal optical thickness provided that lower wavelength λ_{L} is appreciably larger than the wavelength for which the optical thickness of the individual layers is a half-wave. The performance of the resulting multilayer coating is similar to that of the original inhomogeneous layer if the number of sublayers is large enough so that the refractive-index difference between adjacent layers is small compared with (nₛ−nₘ). When this constraint is met, the reflectances at the interfaces of the sublayers remain small.

Referring to FIG. 1E, when medium index nₘ=1.0, it is possible to achieve zero reflectance with a structured coating layer 122 of substrate index nS when the thickness of coating layer 122 exceeds at least one or two wavelengths of the incident light, and the lateral dimensions of the patterns, for example, a series of tetrahedrons, are less than the wavelength of light. When these conditions are satisfied, the substrate/medium structure can be represented by a series of thin coating layers as further described herein with refractive indices that vary gradually from the index nₘ of medium 106 to the index of substrate 104 as shown in FIG. 1F even if the relation n=(nₛnₘ)^{0.5} is not satisfied.

2.0 Broadband, Omnidirectional AR Coatings

In some embodiments, AR coatings for unpolarized light incident upon a surface at angles of incidence ranging from 0 to 90 degrees can be designed for a given substrate of refractive index nₛ and a region of wavelengths λ over which the AR coatings will be effective. By way of example, a substrate with a refractive index nₛ of 3.00 and a wavelength region of 5.0 to 8.0 micrometers (μm) is used herein to design an AR coating with the desired characteristics. The techniques for designing AR coatings with the desired characteristics can, however, be utilized for substrates with other refractive indices nS and other wavelength regions.

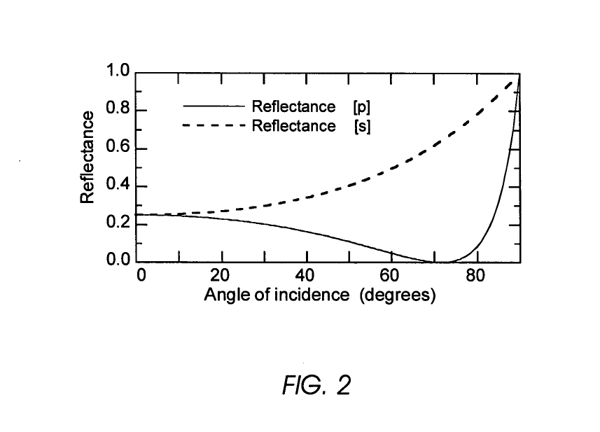

FIG. 2 shows the angular reflectance for p and s-polarized light of an interface between a substrate of refractive index 3.00 and a medium of air (nₘ=1.0). At incidence angles above 70 degrees, the reflectance rises sharply and there is appreciable polarization. These two effects lead to difficulties in designing AR coatings that are effective over a wide range of incidence angles.

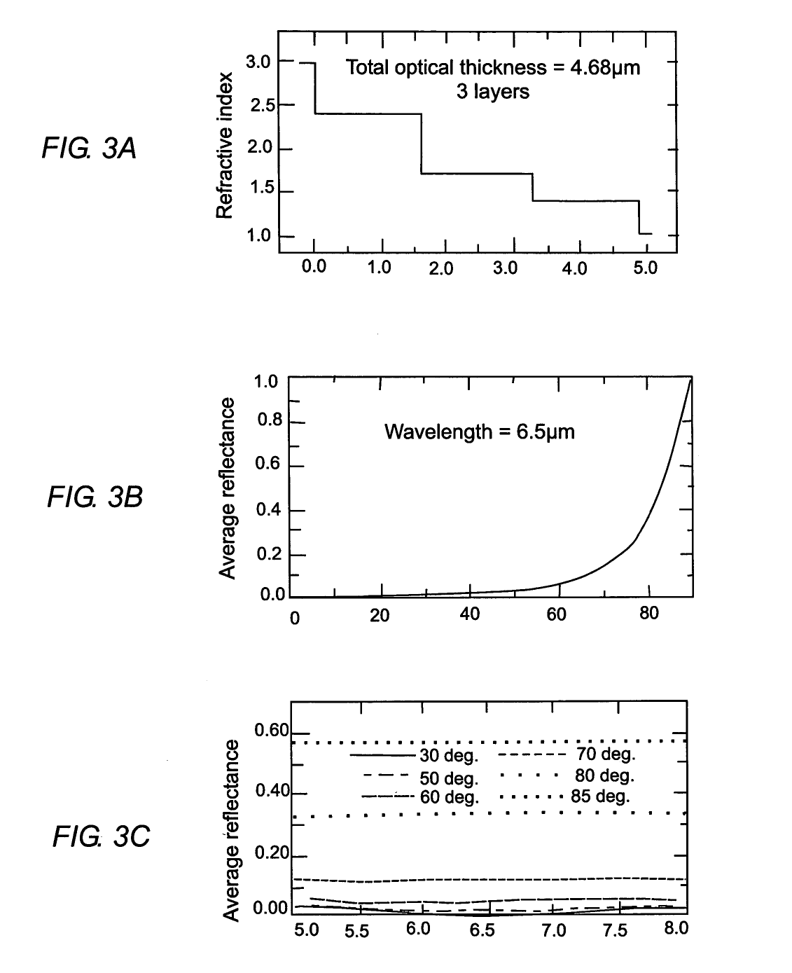

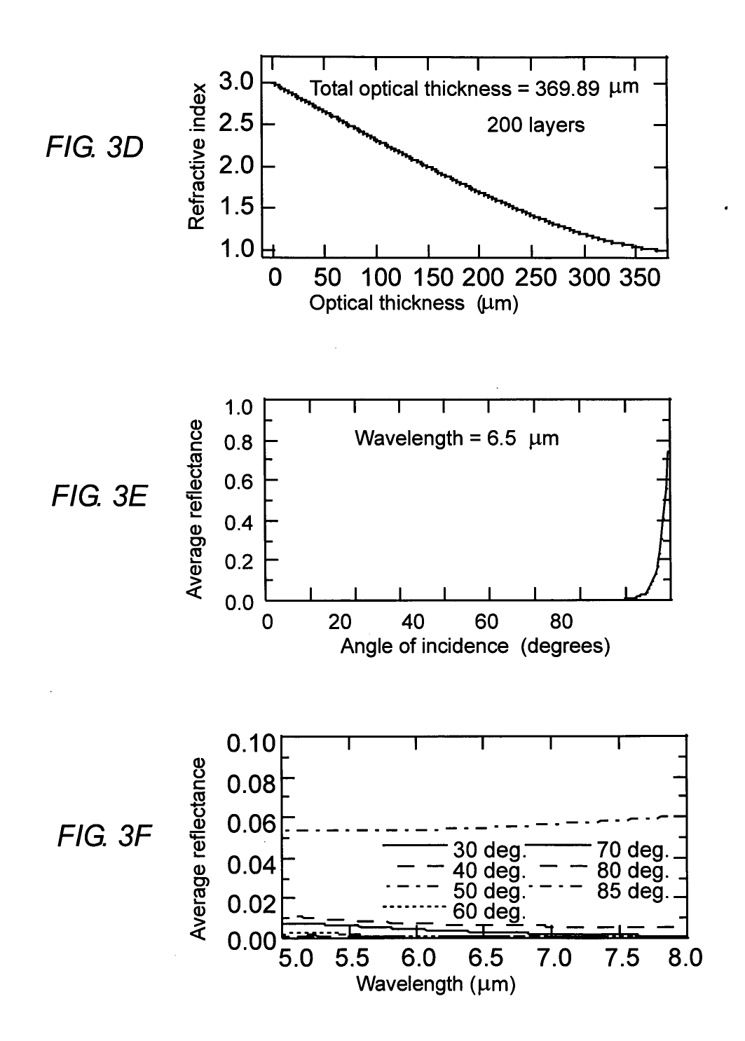

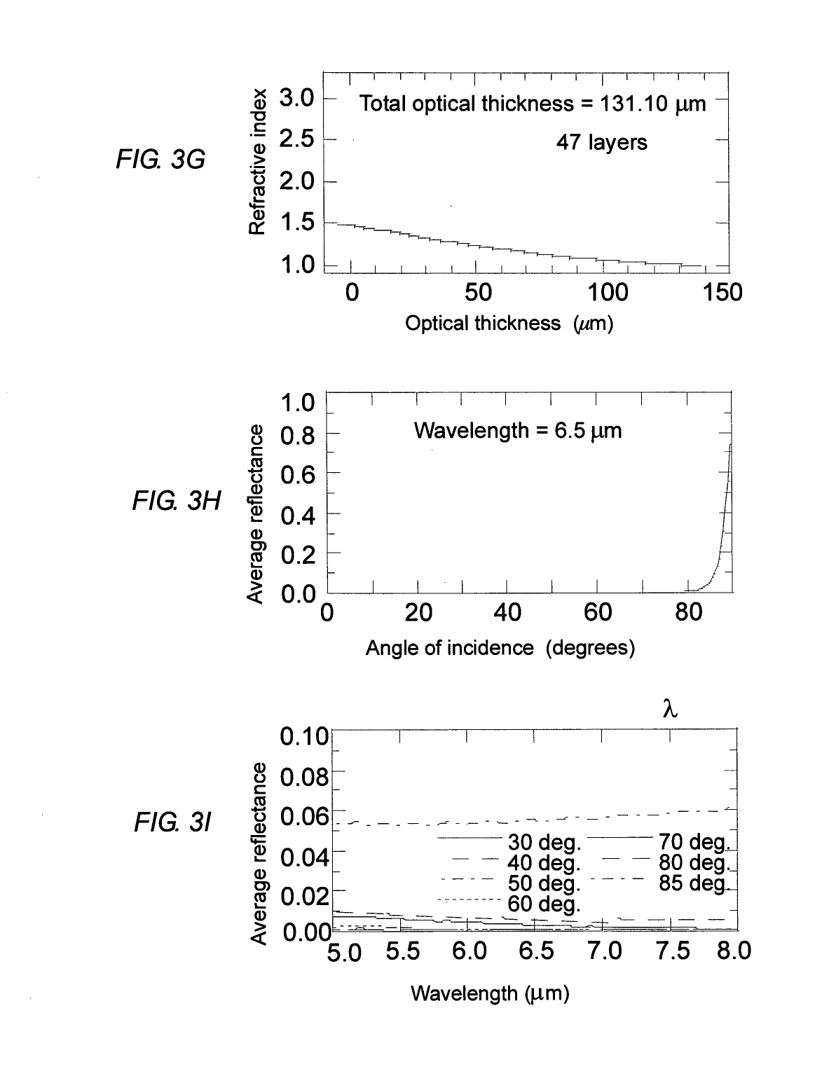

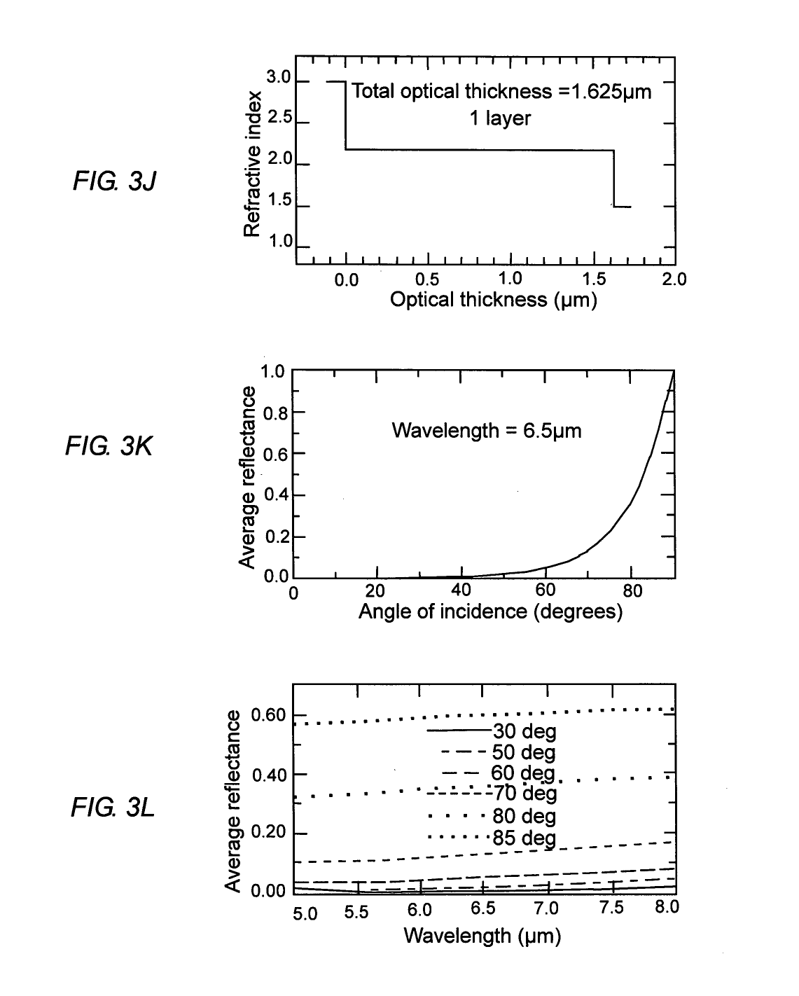

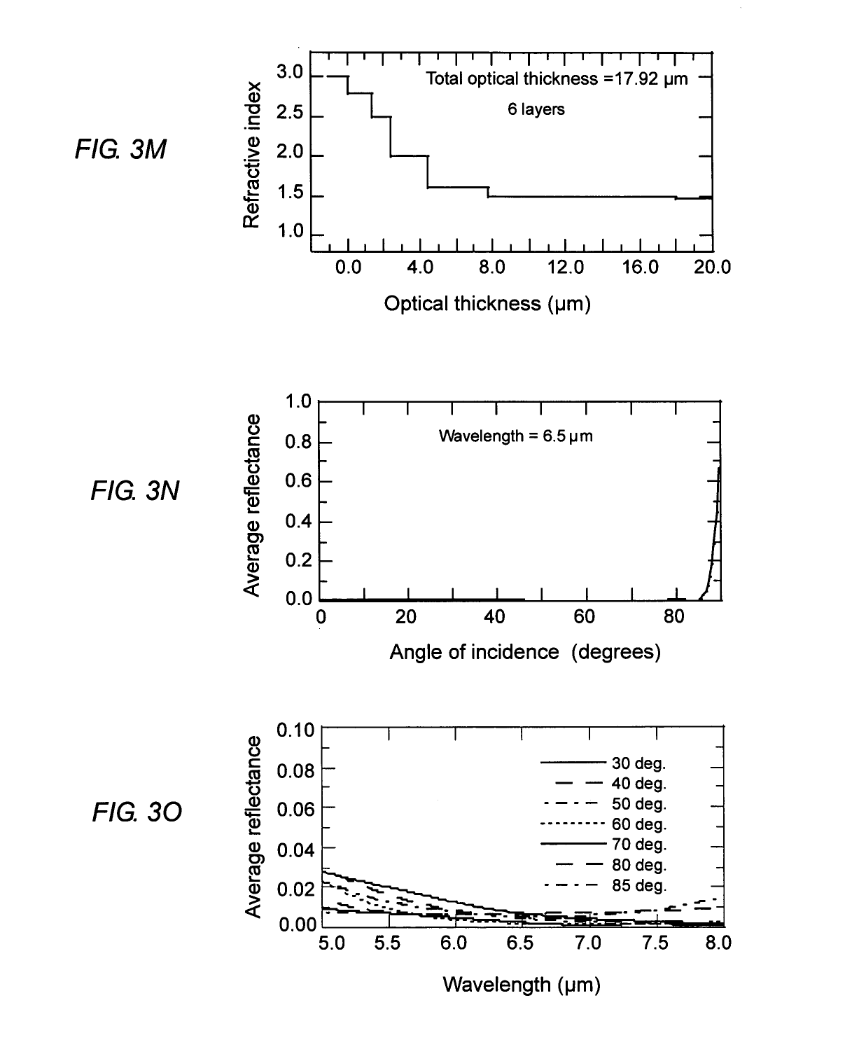

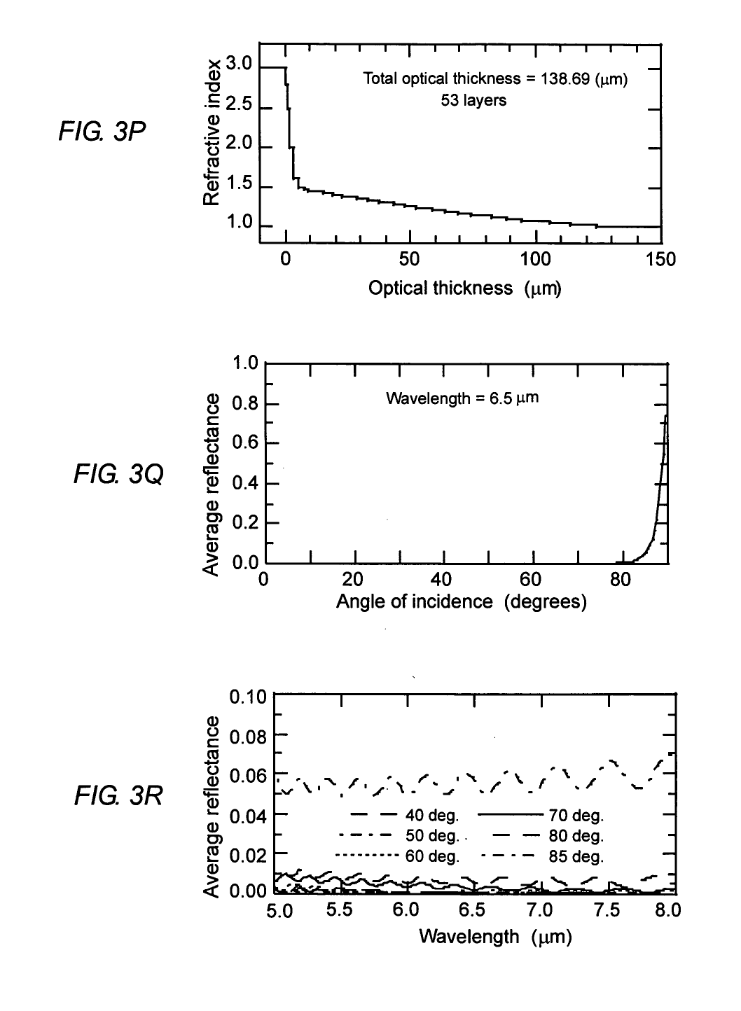

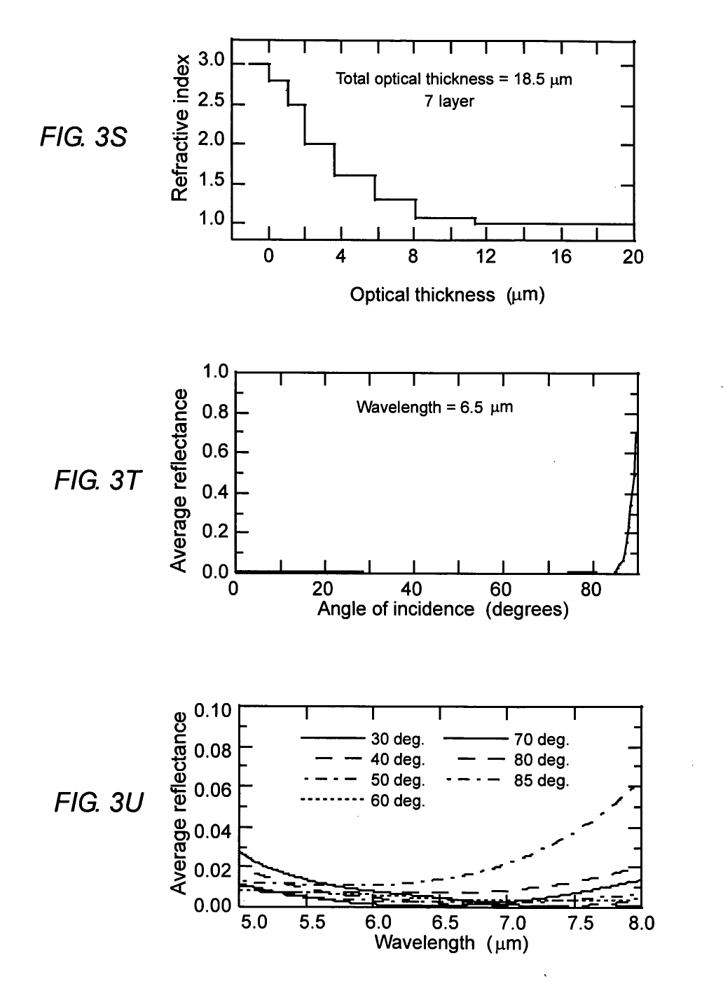

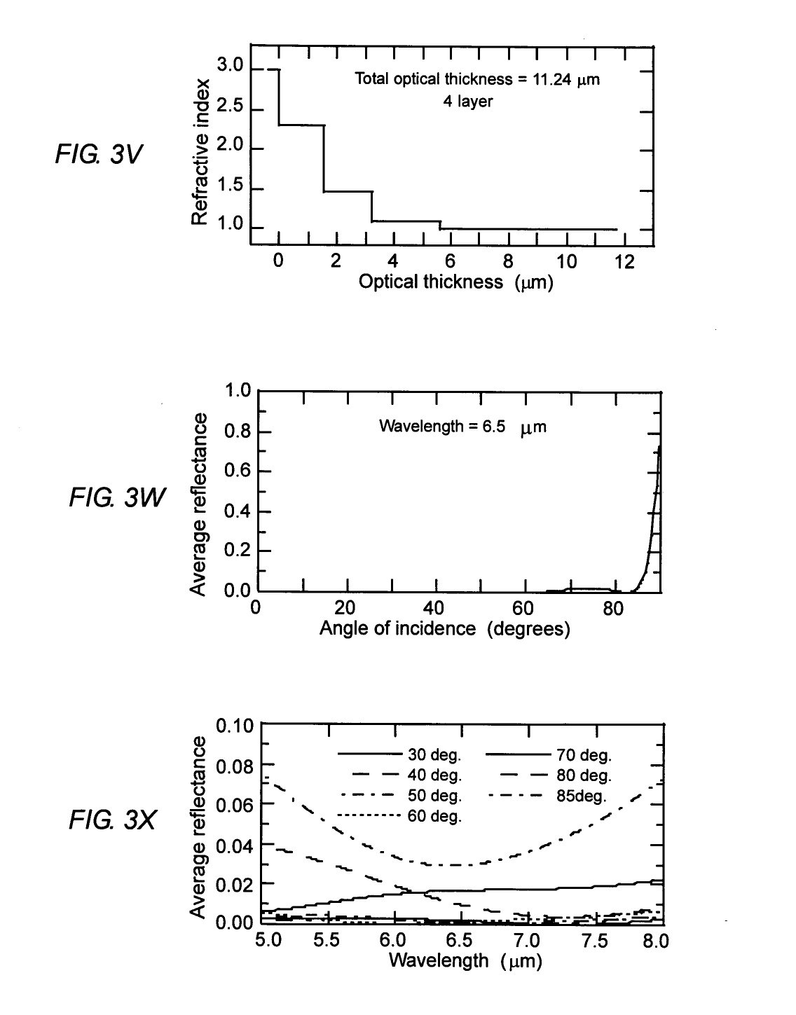

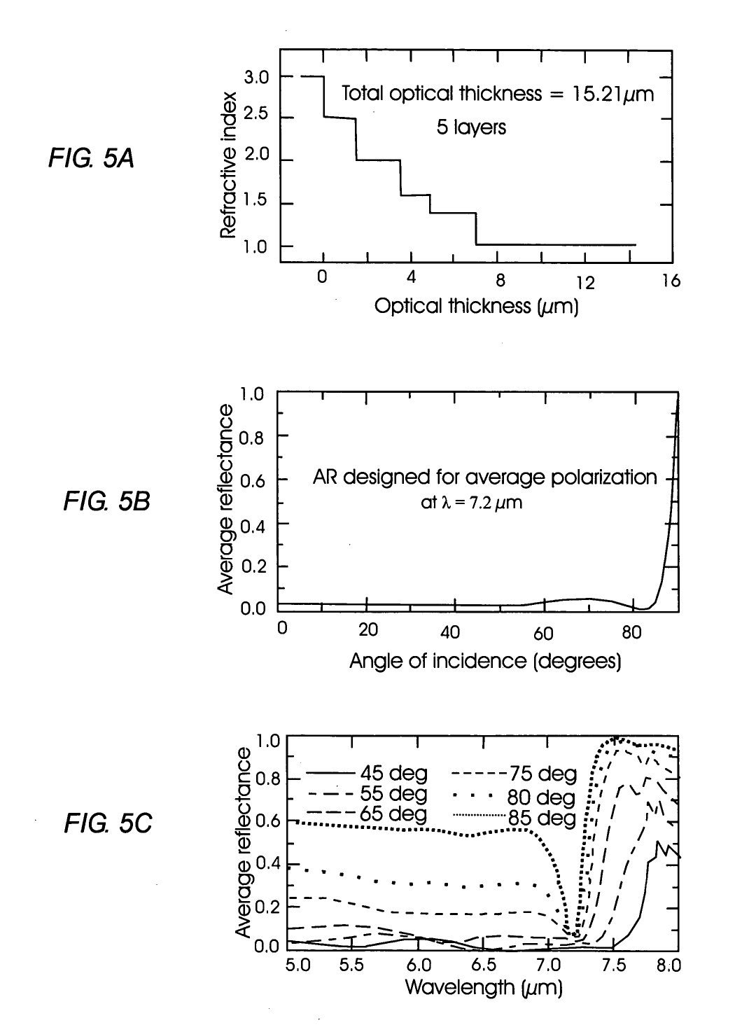

FIG. 3A show the refractive-index profile of a step-down broadband three-layer AR coating for a surface of refractive index 3.00 designed for light at normal (90 degree) incidence angle. The refractive indices and thicknesses of embodiments of optical systems shown in FIGS. 3A, 3M, 3S, 3V, and 5A discussed herein that include relatively few layers are shown in Table 1. FIG. 3B shows the angular variation of the average reflectance Rₐᵥ of the coating of FIG. 3A for p- and s-polarized light at 6.5 μm. Above 70 degrees, the average reflectance exceeds 0.10 and rises steeply for higher angles.

TABLE 1

| | FIG. 3A | | FIG. 3M | | FIG. 3S | | FIG. 3V | | FIG. 5A | |
|---|---|---|---|---|---|---|---|---|---|---|
| Layer No. | n | d (μm) | n | d (μm) | n | d (μm) | n | d (μm) | n | d (μm) |
| Substrate | 3.0000 | | 3.0000 | | 3.0000 | | 3.0000 | | 3.0000 | |
| 1 | 2.3902 | 0.6799 | 2.8000 | 0.4706 | 2.8000 | 0.3668 | 2.3000 | 0.6596 | 2.5000 | 0.6025 |
| 2 | 1.7321 | 0.9382 | 2.5000 | 0.4418 | 2.5000 | 0.3841 | 1.4800 | 1.1616 | 2.0000 | 1.0088 |
| 3 | 1.3800 | 1.1775 | 2.0000 | 0.9778 | 2.0000 | 0.7856 | 1.1000 | 2.1789 | 1.6000 | 0.8828 |
| 4 | | | 1.600 | 2.1491 | 1.6000 | 1.4003 | 1.0200 | 5.4930 | 1.3800 | 1.4867 |
| 5 | | | 1.5000 | 2.9897 | 1.3000 | 1.7183 | | | SiO₂ | 6.0220 |
| 6 | | | 1.4900 | 3.7697 | 1.0700 | 3.0972 | | | | |
| 7 | | | | | 1.0100 | 7.0778 | | | | |
| Medium | 1.0000 | | 1.4800 | | 1.0000 | | 1.0000 | | 1.0000 | |

FIG. 3C depicts the average reflectance for unpolarized light of the coating of FIG. 3A for light incident at angles of 30, 50, 60, 70, 80, and 85 degrees in the spectral region 5.0 μm<λ<8.0 μm. The reflectance at 90 degree incidence angles of all surfaces is unity. Similar coatings can be manufactured for visible wavelengths, and for wavelengths in the near-infrared spectral region for which stable, approximately quarter-wave-thick layers of materials, such as MgF₂, can be produced. FIGS. 3A-3C are provided to compare the calculated angular performance of subsequent AR coating designs disclosed herein with that of the typical normal-incidence AR coating design represented in FIGS. 3A-3C.

AR coatings based on inhomogeneous layers are typically less sensitive to angle of incidence, as described hereinabove. Thus, the structure of a broadband AR coating that is effective over incidence angles between zero and 90 degrees can begin with an inhomogeneous-layer model under the assumption that the refractive index of the inhomogeneous layer varies linearly between the refractive medium index nₘ and substrate index nₛ. Further, the linearly inhomogeneous layer can be adequately modeled by an N-layered multilayer structure in which the refractive-index difference δn between any two adjacent sublayers is

(nₛ−nₘ)/(N+1).

For an angle of incidence θ, the angle of refraction φ within a thin sublayer of refractive index n in the inhomogeneous layer is given by Snell's law:

nₘ sin(θ)=n sin(φ).

Let nd₀ be the 90 degree (normal) incidence angle optical thicknesses of the N sublayers. Then nd is the effective optical thickness of the sublayer of index n for an angle of incidence θ given by the expression

nd_{φ}=nd₀ cos(φ)

The ratio of the normal-incidence to oblique-incidence optical thickness is given by the expression

nd₀/nd_{φ}=sec(φ)

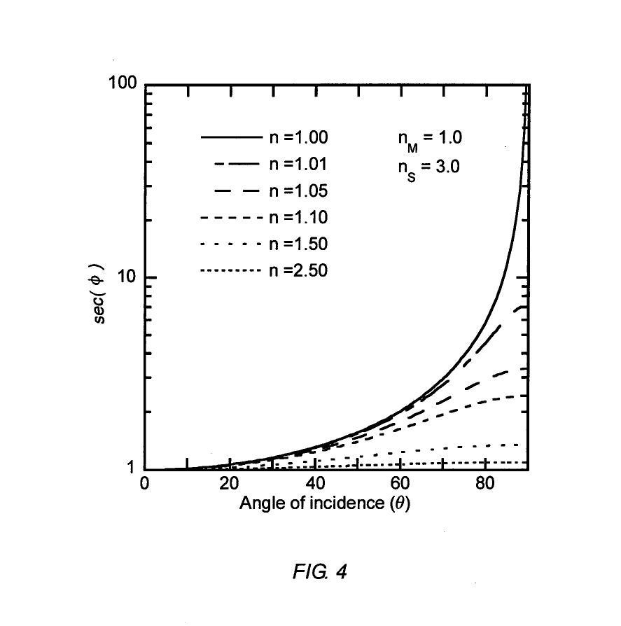

The variation of this ratio with angle of incidence θ for different sublayer refractive indices n is shown in FIG. 4. For sublayers of refractive indices n close to nₘ, the value of the normal-oblique incidence optical thickness ratio for high values of angle of incidence θ lies between 10 and 100. In contrast, for sublayers of refractive indices n close to the value of nₛ, the effective thickness does not vary significantly from that for normal incidence. FIG. 4 shows that the thickness of an inhomogeneous-layer AR coating designed for use at angles greater than 70 degrees will need to be much larger than that for a coating intended for use at normal incidence only.

In view of the above, broadband wide-angle AR coatings can be designed with a thick inhomogeneous AR coating approximated by a large number of homogeneous layers of equal optical thicknesses defined for an oblique angle of incidence. The difference (δn) between the refractive indices of two adjacent sublayers is generally small and constant. In some embodiments, all media and layers are assumed to be non-dispersive and non-absorbing. To reduce the overall thickness of the final AR coating design and for ease of manufacturing, the thickness of the layers are refined, thin and half-wave layers are removed, and adjacent layers with small differences in refractive indices n are consolidated whenever the AR performance, angular variation, and/or bandwidth of the coating does not degrade beyond an acceptable threshold.

FIG. 3D shows the refractive-index profile of a 200-layer simulation of an optical system with an inhomogeneous-layer AR coating for a 3.00-1.00 interface. The refractive indices n of adjacent layers in the optical system differ from one another by 0.01. The sub-layers have one quarter wave optical thickness (QWOT) at a wavelength of 5.5 μm and an angle of incidence of 85 degrees. The total thickness of the AR coating is 369.9 μm. Note that because the optical thicknesses were defined to be equal for an angle of incidence of 85 degrees, the refractive-index profile cannot be approximated by a straight line. Instead, the average reflectance for s- and p-polarized light can be determined as a function of incidence angle for light of 6.5 μm wavelength. The average reflectance remains less than 0.05 for all angles up to approximately 85 degrees as shown in FIG. 3E. FIG. 3F shows that, for angles of incidence of 30, 50, 60, 70, and 80 degrees, the average reflectance is less than 0.01 across the whole 5.0 to 8.0 μm spectral region. Note that the lowest refractive index in the optical system represented in FIG. 3D has a value of 1.01.

Once the thickness of the layers are refined, thin and half-wave layers can be removed, and adjacent layers with small differences in refractive indices n can be consolidated. In some embodiments, the profile of the refractive index n from, for example, 3.0 to 1.48, is truncated, to form a 47-layer AR coating as indicated in FIG. 3G. FIGS. 3H and 3I show that the average reflectance of the resulting system is comparable to that of the system represented in FIGS. 3E and 3F. Using these techniques, step-down AR coatings with similar performance characteristics can be designed for non-absorbing substrates of any refractive index provided that the refractive indices of adjacent layers and the media differ from one another by a small amount, for example, approximately 0.01.

Additionally, an increase or decrease in the value of one quarter wave optical thickness (QWOT) wavelength can result in deteriorated performance of the optical system. When a discrete layer model replaces the inhomogeneous layer, interference effects take place at the abrupt interfaces between the individual layers. The deterioration is proportional to the length of QWOT wavelengths because the optical thickness will approach a half-wave and the layers become absentee layers. The performance deteriorates for shorter QWOT wavelengths because the overall thickness of the system is no longer large enough. The performance can be degraded or improved when the refractive index difference between adjacent layers in the homogeneous-layer simulation is increased or decreased due to the impact on the accuracy of the approximation of the inhomogeneous layer.

Regarding the overall thickness of the layered systems, design parameters such as thickness and refractive indices of the layers can be selected to achieve AR coatings with desirable performance characteristics in multi-layer systems in which interference effects are used. An AR coating for a more narrow spectral region can perform better for the same overall coating thickness or, in some instances, a thinner solution of like performance, than can be obtained with an inhomogeneous-layer AR coating.

For example, with an AR coating for a 3.00-1.48 interface, a conventional single layer design based on the relation n=(nₛnₘ)^{0.5} as indicated by FIG. 3J has an average reflectance that is less than 0.01 for normal incidence across the spectral region of interest. However, the AR coating exhibits degraded performance at higher angles of incidence as indicated by the results shown in FIGS. 3K and 3L.

In some embodiments, a broadband wide-angle AR coating can be simplified, however, by using one or two layers with refractive indices close to 1.48. The refractive-index profile of one such six-layer AR coating is shown in FIG. 3M. The angular and specular performance of the AR coating shown in FIGS. 3N and 3O compares with that of the system of FIGS. 3E and 3F, yet the overall optical thickness of the system is only 17.9 μm. If this system is placed in series with the AR coating for the 1.48-air interface of FIG. 3G, a 53-layer system results, as represented in FIG. 3P. The calculated angular performance of the AR coating shown in FIGS. 3Q and 3R compares with that of the original 200-layer system shown in FIGS. 3D-3F, yet its overall optical thickness of approximately 139 μm is only one third of the thickness of the original coating.

In further embodiments, additional refinement of the layers in the AR coating can further reduce the overall thickness and the number of layers. The AR coating represented in FIG. 3P serves as a baseline design for a target of zero average reflectance for s- and p-polarized light at wavelengths ranging from 5.0 μm<λ>8.0 μm in steps of 0.1 μm and for angles of incidence 75, 80, and 85 degrees. When the thickness of the AR coating is refined, thin and half-wave layers can be removed and layers with close refractive indices can be consolidated whenever the resulting performance does not degrade beyond an acceptable level. In the configuration represented in FIGS. 3S to 3U, the number of layers is reduced from 53 to 7 and the optical thickness was reduced from 120 μm to approximately 18.5 μm. The performance is comparable to that of the original inhomogeneous layer system of FIG. 3D, but the design still requires low refractive indices of 1.01 and 1.07.

The four-layer solution depicted in FIGS. 3V-3X has an even smaller overall thickness (approximately 11.2 μm) and is based on the low refractive indices 1.02 and 1.10, but, as a result, the performance is significantly degraded.

Thus, techniques disclosed herein show that “perfect” AR coatings consisting of relatively few layers and a small overall optical thickness are possible. For example, the high-angle spectral and angular performance of the conventional one-layer AR coating for a 3.00-1.48 interface can be much improved by use of the six-layer AR coating shown in FIGS. 3M-3O.

Other embodiments of techniques for designing broadband onmi-directional AR coatings are based on use of reststrahlen materials. Reststrahlen materials are inorganic materials in which the dispersion of the optical constants is large in the neighborhood of wavelengths that excite lattice vibrations and give rise to sharp absorption bands. In particular, reststrahlen materials also have narrow spectral regions in which the refractive index assumes values less than unity whereas the extinction coefficient of the material is still quite small.

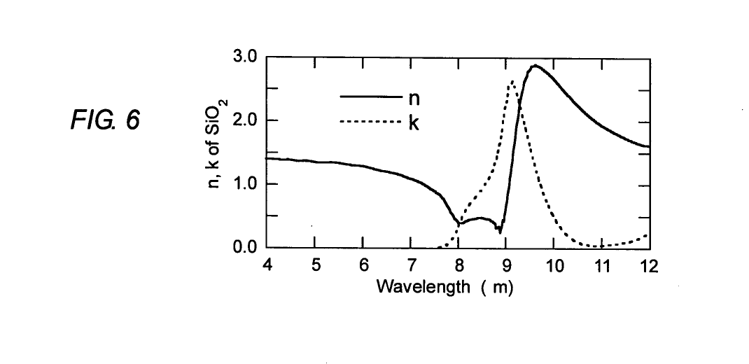

Many reststrahlen materials exist with absorption bands in the near to far infrared spectral regions. For example, FIG. 6 shows a plot of the optical constants of SiO₂ material. At a wavelength of approximately 7 μm, the refractive index of the SiO₂ material has a value of 1.00 and the extinction coefficient is still quite small. These dispersive optical constants can be used to design a four-layer omnidirectional AR coating for a substrate of index 3.00 for the 7.2-μm wavelength. FIGS. 5A-5C show the refractive-index profile and the angular and specular performances of the resulting AR coating. The refractive indices of the remaining three layers were assumed to be nondispersive. The results indicate that, at that particular wavelength, the reflectance for unpolarized light is less than 0.05 for all angles lower than 85°. In addition to the fact that such AR coatings are effective over only a narrow wavelength range, there is a limited number of wavelengths in the infrared spectrum for which suitable reststrahlen materials exist. However, a limited tuning of the AR wavelength can be achieved through the deposition of layers that are mixtures of two or more materials, including a reststrahlen material.

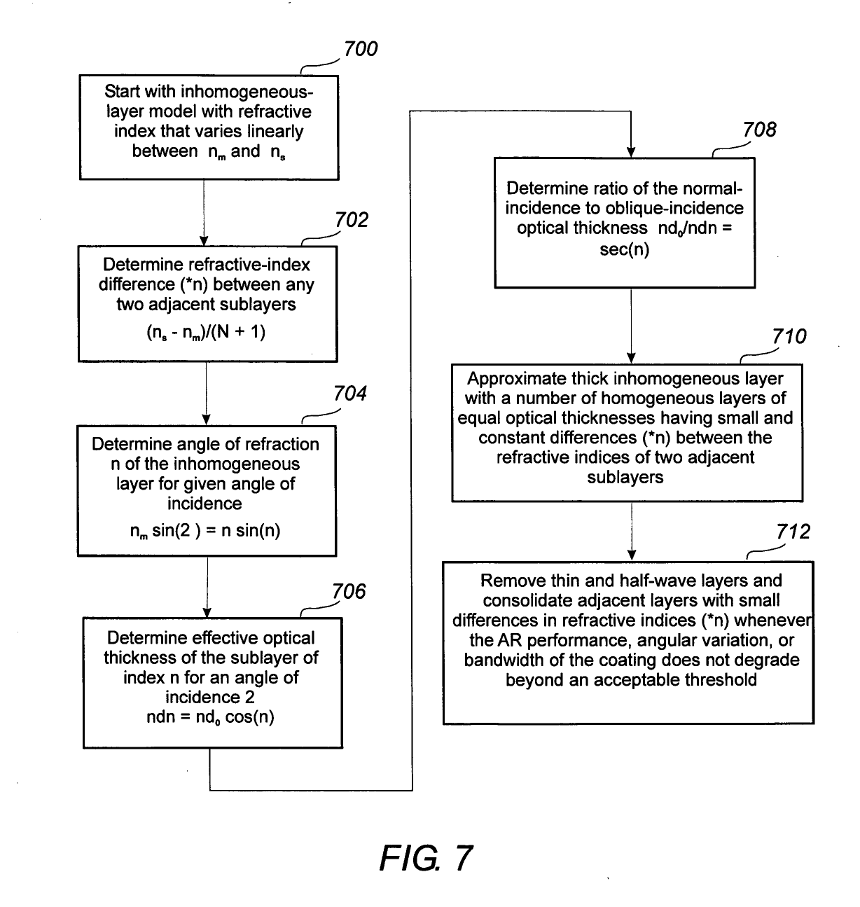

A flow diagram of an embodiment of a method for designing AR coatings is shown in FIG. 7. Process 700 begins with an inhomogeneous-layer model with a refractive index that varies linearly between the refractive medium index nₘ and substrate index nₛ.

Process 702 includes determining the refractive-index difference δn between any two adjacent sublayers using the expression (nₛ−nₘ)/(N+1).

Process 704 includes determining the angle of refraction φ of the inhomogeneous layer for given angle of incidence using the expression nₘsin(θ)=n sin(φ).

Process 706 includes determining the effective optical thickness of the sublayer of index n for an angle of incidence θ using the expression ndφ=nd₀cos(φ).

Process 708 includes determining the ratio of the normal-incidence to oblique-incidence optical thickness using the expression nd₀/ndφ=sec(φ).

Process 710 includes approximating a thick inhomogeneous layer with a number of homogeneous layers of equal optical thicknesses having small and approximately constant differences (δn) between the refractive indices of two adjacent sublayers.

Process 712 includes removing thin and half-wave layers and consolidate adjacent layers with small differences in refractive indices n whenever the AR performance, angular variation, and/or bandwidth of the coating does not degrade beyond an acceptable threshold.

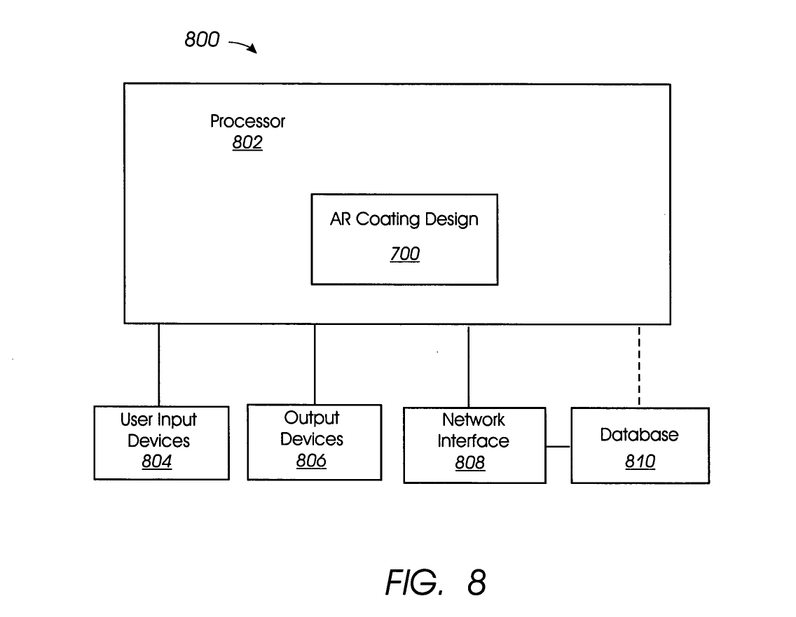

Referring to FIG. 8, a system 800 is shown that can be used to implement at least portions of coating design process 700 with logic instructions, such as software programs that are executed by a processor 802. The logic instructions can be distributed over an information network or suitable computer-readable media as a software application program that can be installed on a personal computer, a centralized server, or other suitable computer system. The logic instructions can also be implemented in hardware, firmware, and/or a combination of hardware, firmware and software. One or more user input devices 804 can be provided, such as a keyboard, mouse, light pen, or a component such as a disk drive that can read data input files from a disk, to enable a designer to enter suitable constraints and design parameters. One or more output devices 806 such as a display device, printer, plotter, or other suitable output device can be coupled to receive information from processor 802. A user interface can also be included that provides instructions for using system 800, possible materials and design parameters that can be varied in performing coating design process 700, as well as other logic instructions, such as plotting routines, that assist the user in evaluating the performance of a particular coating design. The results can be formatted and output for use in other design and manufacturing systems, such as systems that robotically deposit layers of coating on a substrate, via network interface 808, to easily share the results of the design effort. Processor 802 can be configured to access a database 810 either directly or via network interface 808 for mass data storage and retrieval.

Embodiments of the coating disclosed herein can be utilized on any type of device or apparatus where it is desirable to avoid reflecting light at specified wavelengths over a range of incidence angles. For example, embodiments of the coating can be used on aircraft to avoid reflecting signals that would otherwise allow the aircraft to be detected.

While the present disclosure describes various embodiments, these embodiments are to be understood as illustrative and do not limit the claim scope. Many variations, modifications, additions and improvements of the described embodiments are possible. For example, those having ordinary skill in the art will readily implement the processes necessary to provide the structures and methods disclosed herein. Variations and modifications of the embodiments disclosed herein may also be made while remaining within the scope of the following claims. The functionality and combinations of functionality of the individual modules can be any appropriate functionality. In the claims, unless otherwise indicated the article “a” is to refer to “one or more than one”.

What is claimed is:

1. An apparatus with an antireflective (AR) coating, comprising:
a plurality of coating layers, wherein the refractive indices of the layers vary between the refractive index of the substrate on which the coating is deposited, and the refractive index of the medium in which the apparatus is utilized; and the differences in the refractive indices between adjacent layers is less than the difference between the refractive index of the substrate and the refractive index of the medium.

2. The apparatus as set forth in claim 1, wherein the thickness of the coating exceeds at least one wavelength of incident light.

3. The apparatus as set forth in claim 1, wherein at least one of the plurality of layers is formed with patterned substructures, and the lateral dimensions of the patterned substructures are less than the wavelength of the incident light.

4. The apparatus as set forth in claim 1, wherein the wavelength of the incident light is larger than the wavelength for which the optical thickness of the individual layers is a half-wave.

5. The apparatus as set forth in claim 1, wherein coating includes a reststrahlen material.

6. The apparatus as set forth in claim 1, wherein the substrate has a refractive index of approximately 3.0, the medium has a refractive index of approximately 1.0.

7. The apparatus as set forth in claim 1, wherein the refractive indices of the layers between the substrate and the medium vary between approximately 2.8 and approximately 1.01.

8. The apparatus as set forth in claim 1, wherein the difference in the refractive indices between the substrate and the medium is approximately 2.0.

9. The apparatus as set forth in claim 1, wherein the difference in the refractive indices of adjacent layers is less than approximately 0.65.

10. The apparatus as set forth in claim 1, wherein the difference in the refractive indices of the layers is less than approximately 0.4.

11. The apparatus as set forth in claim 1, wherein the optical thickness of each of at least a portion of the layers ranges from approximately 0.36 micrometers to approximately 7 micrometers.

12. A method for developing a broadband anti-reflective (AR) coating, comprising:
approximating a thick inhomogeneous layer with a plurality of thinner layers, wherein the differences between the refractive indices of adjacent layers are smaller than the difference between the refractive index of a substrate for the coating and the refractive index of the medium in which the coating will be utilized; and
consolidating adjacent layers with small differences in refractive indices n whenever the AR performance, angular variation, or bandwidth of the coating does not degrade beyond a predetermined threshold.

13. The method as set forth in claim 12, forming at least one of the plurality of layers with patterned substructures, wherein the lateral dimensions of the patterned substructures are less than the wavelength of incident light.

14. The method as set forth in claim 12, wherein the wavelength of incident light is larger than the wavelength for which the optical thickness of the individual layers is a half-wave.

15. The method as set forth in claim 12, wherein coating includes a reststrahlen material.

16. The method as set forth in claim 12, wherein the substrate has a refractive index of approximately 3.0, the medium has a refractive index of approximately 1.0.

17. The method as set forth in claim 12, wherein the refractive indices of the layers between the substrate and the medium vary between approximately 2.8 and approximately 1.01.

18. The method as set forth in claim 12, wherein the difference in the refractive indices between the substrate and the medium is approximately 2.0.

19. The method as set forth in claim 12, wherein the difference in the refractive indices of adjacent layers is less than approximately 0.65.

20. The method as set forth in claim 12, wherein the difference in the refractive indices of the layers is less than approximately 0.4.

21. The method as set forth in claim 12, wherein the optical thickness of each of at least a portion of the layers ranges from approximately 0.36 micrometers to approximately 7 micrometers.

22. The apparatus as set forth in claim 12, wherein the thickness of the coating exceeds at least one wavelength of incident light.

23. A system for developing a broadband anti-reflective (AR) coating, comprising:
computer executable instructions operable to:
approximate a thick inhomogeneous layer with a plurality of thinner layers, wherein the differences between the refractive indices of adjacent layers are smaller than the difference between the refractive index of a substrate for the coating and the refractive index of the medium in which the coating will be utilized; and
consolidate adjacent layers with small differences in refractive indices n whenever the AR performance, angular variation, or bandwidth of the coating does not degrade beyond a predetermined threshold.

24. The system as set forth in claim 23, further comprising computer executable instructions operable to form at least one of the plurality of layers with patterned substructures, wherein the lateral dimensions of the patterned substructures are less than the wavelength of incident light.

25. The system as set forth in claim 23, wherein the wavelength of incident light is larger than the wavelength for which the optical thickness of the individual layers is a half-wave.

26. The system as set forth in claim 23, wherein coating includes a reststrahlen material.

27. The system as set forth in claim 23, wherein the thickness of the coating exceeds at least one wavelength of incident light.
